(19) United States
(12) Patent Application Publication
(10) Pub. No.: US 2007/0211975 A1
(43) Pub. Date: Sep. 13, 2007

(54) Inner primary bearing race

(75) Inventors: Justin Bramstedt, Viroqua, WI (US); Scott Sjovall, Westby, WI (US)

Correspondence Address: STEPTOE & JOHNSON LLP, 1330 CONNECTICUT AVENUE, N.W., WASHINGTON, DC, 20036, US

(73) Assignee: S & S Cycle, Inc., Viola, WI (US)

(21) Appl. No.: 11/713,736

(22) Filed: Mar. 5, 2007

Related U.S. Application Data
(60) Provisional application No. 60/779,422, filed on Mar. 7, 2006.

(51) Int. Cl. F16C 19/04

(52) U.S. Cl. 384/490

(57) ABSTRACT

An inner primary bearing race includes a tapered inside diameter portion to prevent the inner primary bearing race from walking down a transmission mainshaft into engagement with a transmission output seal or transmission output gear. Tools and methods of installing the inner primary bearing race are also described.

### CLAIM OF PRIORITY

This application claims priority to provisional U.S. Patent Application No. 60/779,422, filed Mar. 7, 2006, titled “Inner Primary Bearing Race,” which is incorporated by reference in its entirety.

### FIELD OF THE INVENTION

The subject invention relates to motorcycle drivetrains and, more particularly, to inner bearing races for motorcycle transmissions.

### BACKGROUND

It is believed that when improving performance above that of a “stock” motorcycle, problems may be revealed that were not previously anticipated. As it is used herein, the term “stock” refers to the configuration of equipment as the equipment manufacturer originally sold it. For example, in the case of a large displacement twin-cylinder motorcycle engine, with increased torque, the stock inner primary bearing race tends to shift on the transmission mainshaft. This so-called “walking,” or displacement along the mainshaft, of the stock inner primary bearing race may result in destruction of the transmission mainshaft seal and eventually destruction of the output gear.

Thus, it is believed that there is a need for an inner primary bearing race that is not susceptible to walking, especially in high performance motorcycle drivetrains.

### SUMMARY

An inner primary bearing race that does not translate along a transmission mainshaft into engagement with a transmission output seal or transmission output gear is described. The inner primary bearing race can be installed in place of a stock inner primary bearing race, particularly in high performance applications of a motorcycle transmission.

A method of removing a stock inner primary bearing race and installing an inner primary bearing race that does not suffer from the disadvantages of the stock inner primary bearing race is also provided, as is a set of tools for removing and installing inner primary bearing races.

A kit including an inner primary bearing race and a set of inner primary bearing race removing and installing tools is additionally described.

In one aspect, an inner bearing race includes a proximal end having a first inner diameter, a distal end having a second inner diameter smaller than the first inner diameter, a first portion having a cylindrical external wall extending axially from the proximal end, and a second portion between the first portion and the distal end, the second portion having an internal wall terminating at the distal end.

In another aspect, a method of replacing an inner bearing race on a motorcycle mainshaft includes removing a stock inner bearing race from the mainshaft, and installing on the mainshaft an inner bearing race that includes a proximal end having a first inner diameter, a distal end having a second inner diameter smaller than the first inner diameter, a first portion having a cylindrical external wall extending axially from the proximal end; and a second portion between the first portion and the distal end, the second portion having an internal wall terminating at the distal end.

In another aspect, a kit for replacing an inner bearing race on a motorcycle mainshaft includes a clutch puller, an inner bearing race puller attachment for the clutch puller, an inner primary bearing race installer, and an inner bearing race. The inner bearing race includes a proximal end having a first inner diameter, a distal end having a second inner diameter smaller than the first inner diameter, a first portion having a cylindrical external wall extending axially from the proximal end, and a second portion between the first portion and the distal end, the second portion having an internal wall terminating at the distal end.

The first portion can have an inner wall having a uniform bore. The inner wall of the first portion can include an annular recess, or in some cases, two annular recesses. The uniform bore of the inner wall can be sized to allow press-fitting on a first portion of a motorcycle mainshaft. The second inner diameter can be smaller than the outer diameter of the first portion of the motorcycle mainshaft.

The inner wall of the second portion can be tapered or stepped. The tapered internal wall can be configured to engage a tapered portion of the motorcycle mainshaft. The second portion c an outer wall having a taper similar to that of the tapered internal wall. The second portion of the inner bearing race can have an outer wall having a taper similar to that of the tapered internal wall. The stepped internal wall can be configured to engage a stepped portion of the motorcycle mainshaft. The second portion of the inner bearing race can have an outer wall has an outer diameter matching that of the cylindrical external wall of the first portion.

Those of ordinary skill in the art will readily appreciate that these and other detailes, features and advantages will become further apparent in view of the description and the attached illustrations and appendices.

### BRIEF DESCRIPTION OF THE DRAWINGS

FIG. 1 is a cross-section view of a partial transmission and clutch assembly including an inner primary bearing race according to a preferred embodiment.

FIG. 2 is a cross-section view of a stock inner primary bearing race on a mainshaft of a known transmission and clutch assembly.

FIG. 3 is a cross-section view of the known transmission and clutch assembly shown in FIG. 2 wherein the stock inner primary bearing race has walked along the mainshaft.

FIG. 4 is a perspective view of a plan view of the inner primary bearing race shown in FIG. 1.

FIG. 5 is an end view and a cross-section view of a preferred embodiment of the inner primary bearing race shown in FIG. 1.

### DETAILED DESCRIPTION

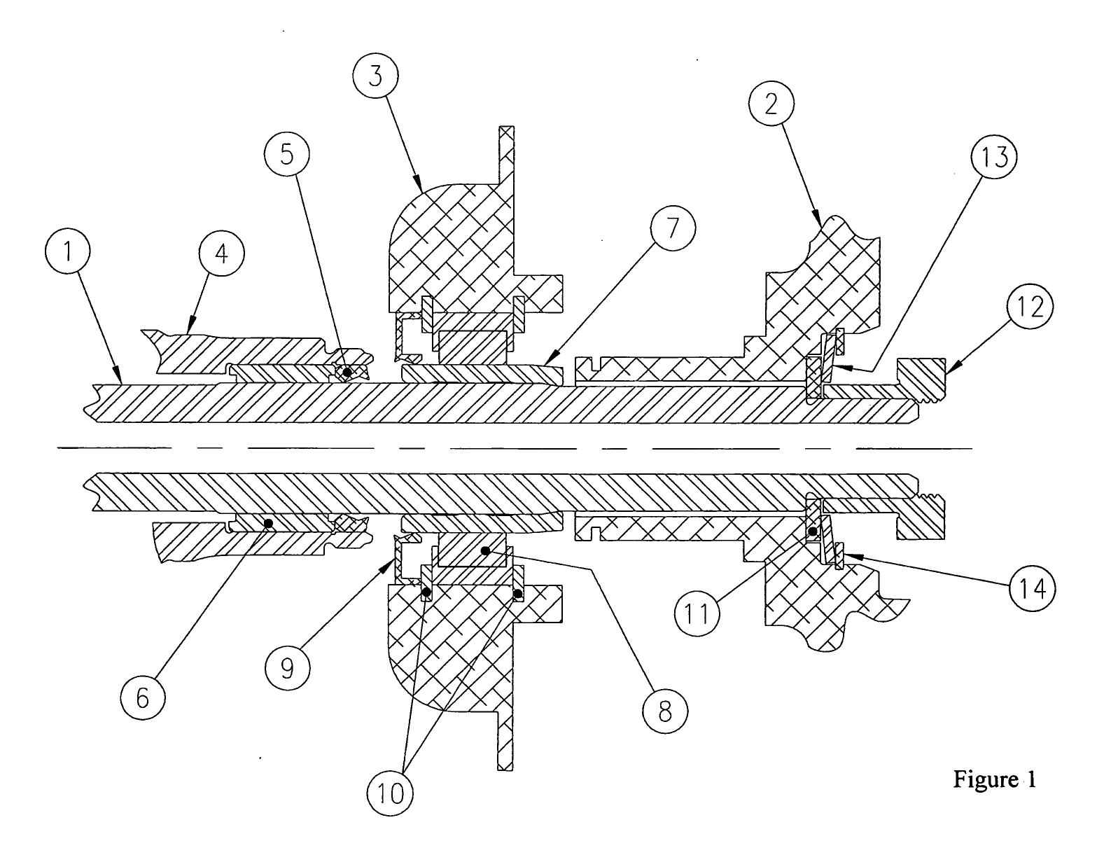

Referring now to FIG. 1, an inner primary bearing race 7 is shown mounted on a first portion (having a first outer diameter) of a mainshaft 1 of a motorcycle transmission. The inner primary bearing race 7, in cooperation with inner primary bearing 8, supports the mainshaft 1 for relative rotation with respect to inner primary housing 3. The inner primary bearing 8 preferably includes an outer primary bearing race and a plurality of antifriction devices, e.g., rollers, balls, etc. As is known, the outer primary bearing race includes a groove in which the antifriction devices roll and which delimits movement of the antifriction devices along the axis of the mainshaft 1. Retaining rings 10 (two are shown) delimit movement along the axis of mainshaft 1 of the outer primary bearing race with respect to the inner primary housing 3. An inner bearing seal 9 prevents the transfer of fluids, e.g., lubricant, and contaminants between the inner primary housing 3 and the inner primary bearing race 7.

A transmission output gear 4 is also supported for relative rotation on the mainshaft 1 by virtue of output gear bearing 6. In particular, the transmission output gear 4 is supported on a first portion of the mainshaft 1 that has a circular outside diameter. An output gear seal 5 prevents the transfer of fluids, e.g., lubricant, and contaminants between the mainshaft 1 and the transmission output gear 4.

A clutch hub 2 is secured to the mainshaft 1 by virtue of a flat washer 11, a retaining nut 12, a Belleville washer 13 and a retaining ring 14. The clutch hub 2 is further secured with respect to the mainshaft 1 via a splined connection at a second portion (having a second outer diameter) of the mainshaft 1. The outside diameter of the splines (i.e., the second outer diameter) on the mainshaft 1 is smaller than the first outer diameter of the first portion of the mainshaft 1, and a tapered portion of the mainshaft 1 extends between the first and second portions. In other words, the first portion of the mainshaft 1 is joined to the second portion of the mainshaft 1 by a tapered portion of the mainshaft 1. In some cases, the first portion of the mainshaft 1 is joined to the second portion of the mainshaft 1 by a stepped portion of the mainshaft 1, rather than a tapered portion.

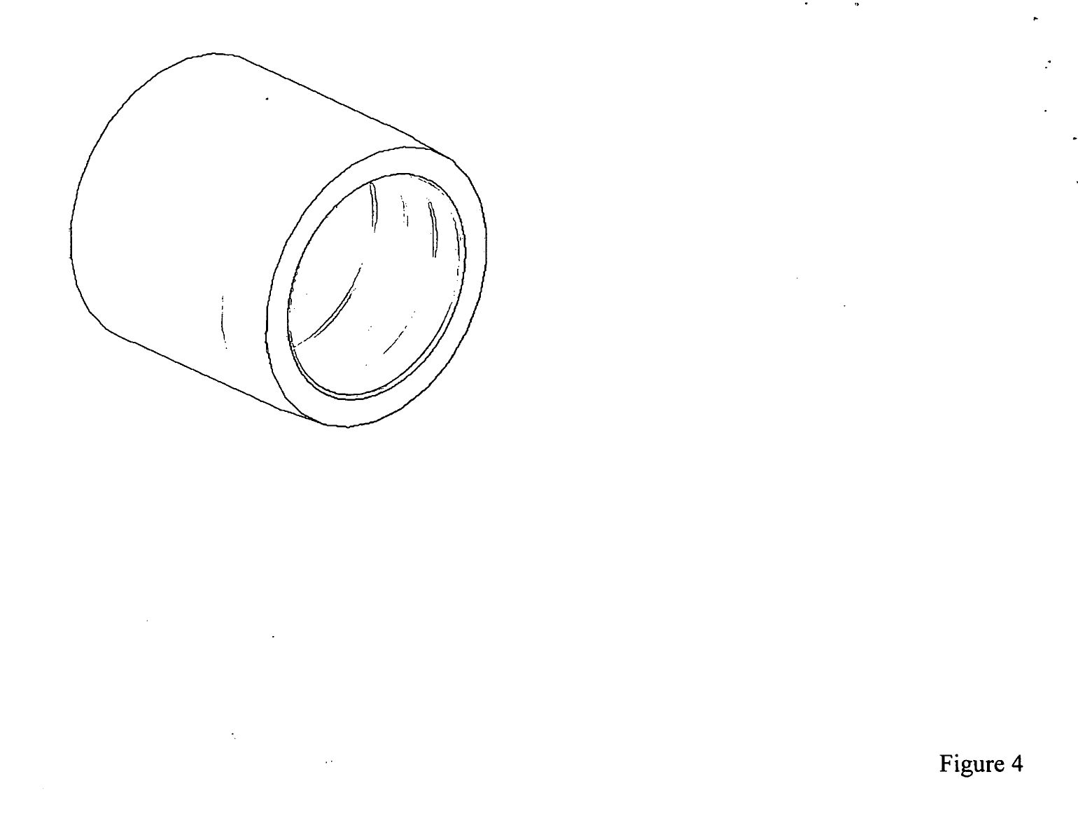

With additional reference to FIG. 4, the inner primary bearing race 7 includes a generally cylindrical body having a first portion disposed proximate to the transmission output gear 4 and a second portion disposed proximate to the clutch hub 2. The first portion of the cylindrical body of the inner primary bearing race 7 preferably includes a substantially uniform outside diameter that corresponds to the diameter upon which the antifriction devices of inner primary bearing 8 roll. A substantially uniform outer diameter is one sufficiently uniform to be useful as a bearing race; it can be achieved using standard machining techniques and can be substantially free of nicks, burrs, or the like. With respect to the cylindrical body, the substantially uniform outer diameter is one that does not vary along the axis of the cylinder.

The inside diameter of the first portion of the cylindrical body of the inner primary bearing race 7 may have a uniform bore that corresponds to the outside diameter of the mainshaft; more particularly, the inside diameter of the first portion of the cylindrical body of the inner primary bearing race 7 can corresponds to the outside diameter of the first portion of the mainshaft. Preferably, the inside diameter of the first portion of the cylindrical body may have at least one annular recess, and preferably two recesses, to facilitate press-fitting of the inner primary bearing race 7 onto the mainshaft 1. The second portion of the cylindrical body of the inner primary bearing race 7 preferably includes a tapered inside diameter that corresponds to the tapered portion of the mainshaft 1. In the case of stepped mainshaft, the second portion of inner primary bearing race 7 can have a stepped inside diameter that corresponds to the stepped portion of the mainshaft 1. The outside diameter of the second portion of the cylindrical body of the inner primary bearing race 7 may have a taper similar to the inside diameter, or may have the same outside diameter of the first portion of the cylindrical body of the inner primary bearing race 7. Although the inner primary bearing race 7 is described with regard to a first portion and a second portion, it can be constructed as a unitary item, e.g., as a single piece of machined material.

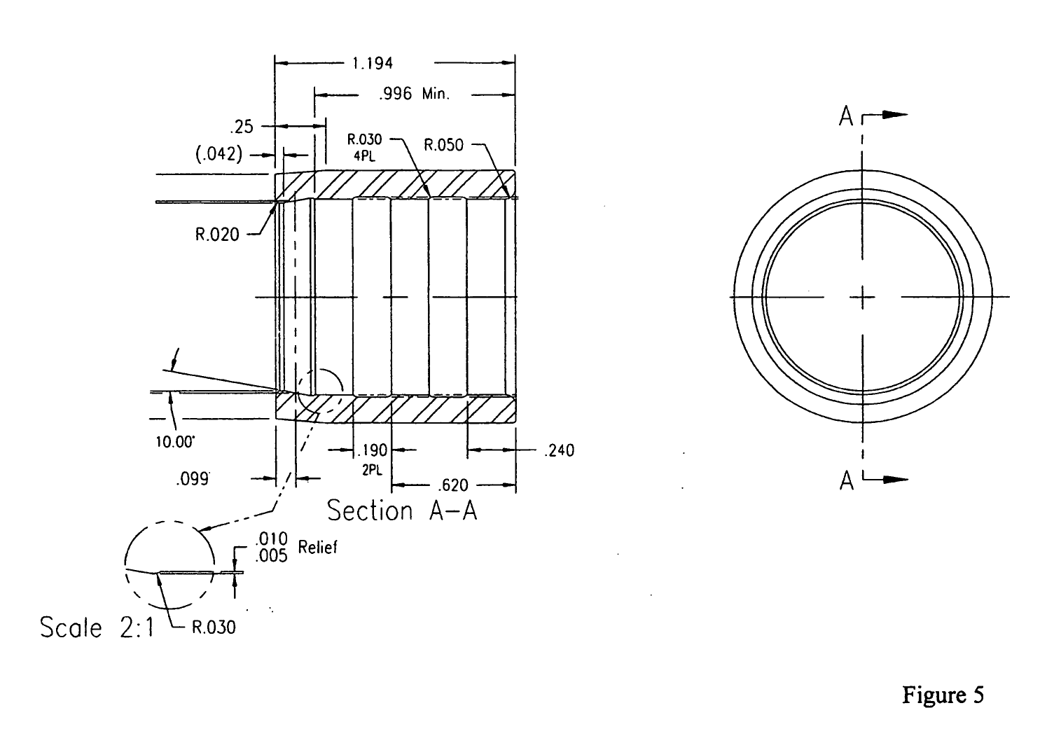

FIG. 5 illustrates the relative dimensions of a preferred embodiment of the inner primary bearing race 7.

Thus, the tapered or stepped inside diameter of the second portion of the cylindrical body of the inner primary bearing race 7 can engage the tapered or stepped portion of the mainshaft 1 and thereby positively prevents the inner primary bearing race 7 from walking along the mainshaft 1 toward the transmission output gear 4.

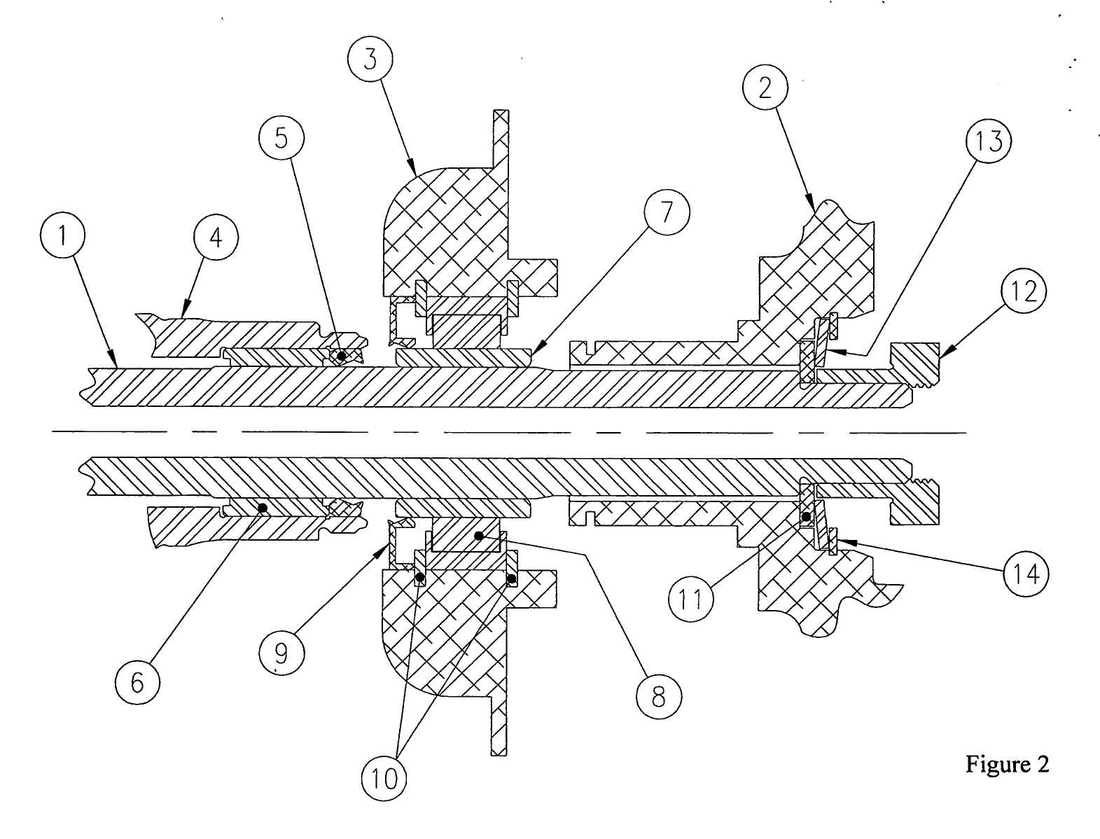

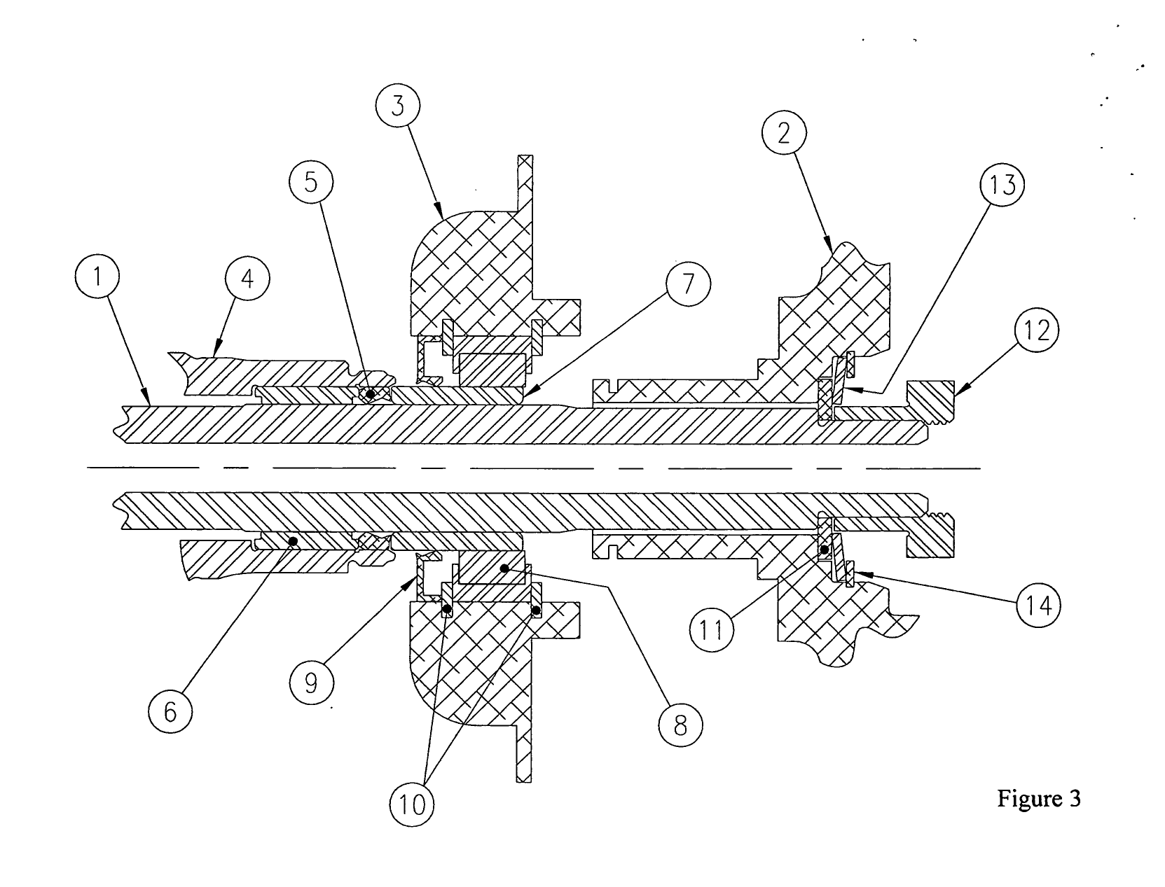

In contrast, FIGS. 2 and 3 show a conventional arrangement wherein the same reference numerals refer to the same features, except that in FIGS. 2 and 3, reference numeral 7 refers to a stock inner primary bearing race. As is illustrated by the differences between FIGS. 2 and 3, the stock inner primary bearing race 7 is not prevented from walking along the mainshaft 1 toward the transmission output gear 4. And as shown in FIG. 3, eventually the stock inner primary bearing race 7 may walk along the mainshaft 1 so as to contact and potentially damage or destroy the output gear seal 5 or the output gear bearing 6.

The process by which a stock inner primary bearing race 7 is replaced with a inner primary bearing race 7 is described in Appendix A of U.S. Patent Application No. 60/779,422, which is incorporated by reference in its entirety.

Similarly, a preferred embodiment of a primary inner bearing race tool set, which may be used during the process described in Appendix A of U.S. Patent Application No. 60/779,422, is illustrated in Appendix B of U.S. Patent Application No. 60/779,422, which is also incorporated by reference in its entirety. Preferably, the primary inner bearing race tool set includes a clutch puller with an inner bearing race puller attachment and an inner primary bearing race installer. According to a preferred embodiment of the tool set, the inner primary bearing race puller is operated by a ⅜-inch ratchet that provides improved leverage and reduces disassembly effort by 50%. According to a preferred embodiment of the tool set, the inner primary bearing race installer features a radial thrust bearing that reduces by 30% the effort required to press the race onto a transmission mainshaft.

In combination with the inner primary bearing race 7 according to the present invention, the primary inner bearing race tool set illustrated in Appendix B forms a kit for removing a stock inner primary bearing race 7 and installing a inner primary bearing race 7 according to the present invention.

Other embodiments are within the scope of the claims.

What is claimed is:

1. An inner bearing race comprising:
a proximal end having a first inner diameter;
a distal end having a second inner diameter smaller than the first inner diameter;
a first portion having a cylindrical external wall extending axially from the proximal end; and
a second portion between the first portion and the distal end, the second portion having an internal wall terminating at the distal end.

2. The inner bearing race of claim 1, wherein the first portion has an inner wall having a uniform bore.

3. The inner bearing race of claim 2, wherein the inner wall of the first portion includes an annular recess.

4. The inner bearing race of claim 3, wherein the inner wall of the first portion includes two annular recesses.

5. The inner bearing race of any one of claims 2 to 4, wherein the uniform bore of the inner wall is sized to allow press-fitting on a first portion of a motorcycle mainshaft.

6. The inner bearing race of claim 5, wherein the second inner diameter is smaller than the outer diameter of the first portion of the motorcycle mainshaft.

7. The inner bearing race of claim 6, wherein the inner wall of the second portion is tapered.

8. The inner bearing race of claim 6, wherein the inner wall of the second portion is stepped.

9. The inner bearing race of claim 7, wherein the tapered internal wall is configured to engage a tapered portion of the motorcycle mainshaft.

10. The inner bearing race of claim 7, wherein the second portion has an outer wall having a taper similar to that of the tapered internal wall.

11. The inner bearing race of claim 8, wherein the stepped internal wall is configured to engage a stepped portion of the motorcycle mainshaft.

12. The inner bearing race of any one of claims 1-4 and 6-11, wherein the second portion has an outer wall has an outer diameter matching that of the cylindrical external wall of the first portion.

13. A method of replacing an inner bearing race on a motorcycle mainshaft comprising:
removing a stock inner bearing race from the mainshaft, and
installing on the mainshaft an inner bearing race comprising:
a proximal end having a first inner diameter;
a distal end having a second inner diameter smaller than the first inner diameter;
a first portion having a cylindrical external wall extending axially from the proximal end; and
a second portion between the first portion and the distal end, the second portion having an internal wall terminating at the distal end.

14. The method of claim 13, wherein the first portion has an inner wall having a uniform bore.

15. The method of claim 13, wherein the inner wall of the first portion includes an annular recess.

16. The method of claim 15, wherein the inner wall of the first portion includes two annular recesses.

17. The method of any one of claims 13 to 16, wherein the uniform bore of the inner wall is sized to allow press-fitting on a first portion of a motorcycle mainshaft.

18. The method of claim 17, wherein the second inner diameter is smaller than the outer diameter of the first portion of the motorcycle mainshaft.

19. The method of claim 18, wherein the inner wall of the second portion is tapered.

20. The method of claim 18, wherein the inner wall of the second portion is stepped.

21. The method of claim 19, wherein the tapered internal wall is configured to engage a tapered portion of the motorcycle mainshaft.

22. The method of any one of claims 19, wherein the second portion has an outer wall having a taper similar to that of the tapered internal wall.

23. The method of claim 20, wherein the stepped internal wall is configured to engage a stepped portion of the motorcycle mainshaft.

24. The method of any one of claims 13-16 and 18-23, wherein the second portion has an outer wall has an outer diameter matching that of the cylindrical external wall of the first portion.

25. A kit for replacing an inner bearing race on a motorcycle mainshaft comprising:
a clutch puller;
an inner bearing race puller attachment for the clutch puller;
an inner primary bearing race installer; and
an inner bearing race comprising:
a proximal end having a first inner diameter;
a distal end having a second inner diameter smaller than the first inner diameter;
a first portion having a cylindrical external wall extending axially from the proximal end; and
a second portion between the first portion and the distal end, the second portion having an internal wall terminating at the distal end.
